(19) United States
(12) Patent Application Publication
(10) Pub. No.: US 2024/0002687 A1
(43) Pub. Date: Jan. 4, 2024

(54) Composition for coating of optical substrates and the use thereof

(71) Applicant: Inkron Oy, Espoo (FI)

(72) Inventors: Jarkko Heikkinen, Espoo (FI); Mikko Poutanen, Espoo (FI); Juha Jääskeläinen, Espoo (FI); Noriyuki Masuda, Espoo (FI)

(21) Appl. No.: 18/036,901

(22) PCT Filed: Nov. 15, 2021
(86) PCT No.: PCT/FI2021/050772

§ 371 Date: May 15, 2023

(30) Foreign Application Priority Data
Nov. 13, 2020 (FI) 20206152

(51) Int. Cl. C09D 11/324; C08G 77/14; C09D 11/328

(52) U.S. Cl. CPC C09D 11/324; C08G 77/14; C09D 11/328

(57) ABSTRACT

Black coatings on optical substrates, compositions for producing such coatings and the use of the compositions for edge-blackening and stray light control. The present coatings comprise a film formed by a cured polymer mixed with nanoparticles and black pigment, wherein the film has a refractive index of more than 1.6. The present compositions comprise 5 to 100 parts by weight of a curable polymer; 5 to 100 parts by weight of nanoparticles; and 0.1 to 20 parts by weight of black pigment, and the nanoparticles and black pigment are mixed with the curable polymer. The present compositions exhibit RI values which match that of high-RI glass substrates while providing efficient edge-blackening properties.

### FIELD OF THE INVENTION

The present invention relates to coating of optical substrates using compositions containing curable polymers mixed with fillers. More specifically, the present invention concerns black coatings on optical substrates, compositions for producing such coatings and the use of the compositions for edge-blackening and stray light control.

### BACKGROUND

Edge-blackening coatings are applied on edges of optical substrates, or at specific limited locations of the optical substrates, specifically on substrates where light propagates inside the substrate. Typically, the coating is applied on optical components such as lenses, prisms, beam splitters, waveguides or diffractive optical elements to minimize undesired reflection of the light propagating inside the optical substrate from the substrate-air interfaces. Additionally, edge-blackening minimizes the light entering the optical substrate through the coated areas. The edge regions typically comprise non-polished rough surfaces. Light reflecting from the edges typically leads to stray light, which is a common limiting factor for the performance of the optical system.

To achieve a proper reduction of reflection, the material used for coating should have a refractive index, more specifically the real part of the complex refractive index, which matches that of the substrate. Traditional edge-blackening coatings do not, however, have high refractive indices and they do not perform well on high refractive index (RI) substrates. The k-value, i.e. the complex part of the RI, is always non-zero in black materials, i.e. absorbing materials, and it partly contributes to the reflectance.

### SUMMARY OF THE INVENTION

The present invention is based on the idea of providing a black coating, which comprises a film formed by a cured polymer mixed with nanoparticles and black pigment. The film has a refractive index of more than 1.55 at wavelength of 589 nm.

A composition for forming coatings on optical substrates typically comprises
a curable polymer;
nanoparticles; and
black pigment;
   the nanoparticles and black pigment being mixed with the curable polymer.

A method of producing a composition for coating of optical substrates comprises the steps of
providing a curable polymer in a solvent phase;
adding to the curable polymer in the solvent phase nanoparticles to provide a mixture, and
adding to the mixture thus obtained a black pigment.

The compositions can be used for high refractive index edge-blackening or stray light control of a high refractive index material. In particular, the compositions are useful for edge-blackening of high refractive index material comprising optical substrate.

More specifically, the present invention is characterized by what is stated in the characterizing part of the independent claims.

Considerable advantages are obtained by the present invention.

The present compositions exhibit RI values which match that of high-RI glass substrates while providing efficient edge-blackening properties.

Typically, the cured materials will have a high refractive index, typically a RI in the range of 1.55 to 2.0 as measured at 589 nm.

By the use of nanoparticles as fillers, the RI can be tailored to match those of various substrates. The optical density, i.e. the logarithm of base 10 of reciprocal transmittance, can be modified by the black pigment.

The compositions can be provided in solvent free form to allow for solvent free products.

The compositions can also be mixed with solvent to adjust viscosity and to allow for application by various contacting and non-contact methods. The materials are thermally curable.

### BRIEF DESCRIPTION OF THE DRAWINGS

FIG. 1 shows optical density spectra relating to the formulations of Example 1 at a thickness of 26 μm; and

FIG. 2 shows the corrected reflectivities of glass-coating interfaces according to an embodiment.

### EMBODIMENTS

It is noted that, as used herein, the singular forms of “a”, “an” and “the” include plural referents unless the context clearly dictates otherwise. It will be further understood that the term “comprises” and/or “comprising”, when used in this specification, specify the presence of stated features, steps, operations, elements, and/or components, but do not preclude the addition of one or more other features, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The “particle size” and “average particle size”, indicated herein, refers to the Z-average particle size that is the intensity weighted mean of the hydrodynamic diameter is determined by light scattering, in particular by dynamic light scattering.

As used herein, unless otherwise indicated, the term “average molecular weight” refers to a weight average molecular weight (also abbreviated “M_{w}” or “Mw”).

The molecular weights have been measured by gel-permeation chromatography using polystyrene standards.

As used herein, unless otherwise stated, the term “viscosity” stands for dynamic viscosity, at 25° C., determined by a rheometer at a 10 s⁻¹ shear rate.

In the present context, the term “black pigment” stands for a pigment or a particle having an absorption coefficient in the range of visible light radiation, i.e. approximately between 380 to 665 nm, leading to a visually black appearance. For example, when the black pigment is present in a 30 μm thick coating at concentration of 7.5%, the coating will have optical density higher than 2, for example 4 or more, measured by spectrophotometer.

In the present context, the term “black coating” stands for a coating which contains a black pigment and which coating has an optical density higher than 2, measured by spectrophotometer in the range of visible light radiation, that is approximately between 380 to 665 nm.

In the present context, “optical substrate” stands for a material, or a stack of materials which have high internal transmittance (higher than 90%), and typically low levels of attenuation (lower than 10%) due to scattering or luminescence at the used wavelengths of light, typically at visible wavelengths. In the present context, the optical substrate onto which the coating is applied has high refractive index, in particular, the refractive index of the optical substrate is on the order of 1.6 or more, in particular about 1.7 to 2.5, typically 1.75 to 2.3 at the wavelength of 589 nm.

The optical substrate can comprise an amorphous material, such as glass, crystalline material such as a mineral crystalline material, polymeric material, or an optical coating comprising for example inorganic fillers embedded in a polymeric matrix. The optical substrate can be for example in the form of a wafer material and the optical substrates can be comprised of a single layer or they can comprise multilayer structures.

In one embodiment, the optical substrate is an optical glass, such as flint glass or crown glass. It may further contain additives, such as zinc oxide, boric oxide, barium oxide, fluorite or lead or combinations thereof.

Embodiments of the present technology provide high RI edge-blackening and/or stray light control materials.

Embodiments further provide formulations which can be applied onto an optical substrate, such as a glass wafer to achieve a black coating.

In embodiments, the present formulations comprise—or consist of or consist essentially of—a binder, such as a curable polymer, in particular a prepolymer with cross-linking groups, such as a siloxane polymer, which is mixed with nanoparticles, such as titanium dioxide, to adjust the refractive index (RI) to match that of the optical substrate, and a black pigment, such as soot or carbon black, to achieve high optical density.

Thus, in one embodiment, the black coating comprises a film having a thickness of 5 to 100 μm, such as 10 to 50 μm. In one embodiment, the black coating comprises a film which exhibits, at a film thickness of 30 μm, an optical density of more than 4 at wavelengths between 400 and 665 nm.

In one embodiment, the cured polymer is polysiloxane. The cured polymer exhibits typically a molecular weight (Mw) of 3,000 to 200,000 g/mol, in particular 5,000 to 100,000 glmol.

In one embodiment, the nanoparticles are selected from metal oxide particles. Examples of such particles include titanium dioxide, zirconium oxide, hafnium oxide, germanium oxide, aluminium oxide and combinations thereof.

In one embodiment, the nanoparticles have an average particle size of 1 to 200 nm, in particular 2 to 100 nm.

In one embodiment, the weight ratio of nanoparticles to cured polymer amounts to 95:5 to 5:95, in particular 90:10 to 10:90, for example 85:15 to 60:40.

In one embodiment, the black pigment is selected from soot, carbon black, graphite, synthetic graphite, carbon nanotubes, metal complex dyes and metal oxide particles and combinations thereof. The black pigment can also comprise black organic pigments.

The concentration of the black pigment in the film is about 1 to 20%, calculated from the weight of the curable polymer and the nanoparticles.

The black pigment, for example carbon black, typically exhibits an average particle size of its primary particles of about 10 to 100 nm, whereas the secondary particles such as agglomerates have a particle size of about 1 to 100 μm.

In one embodiment, the average particle size of the black pigment is lower than the film thickness of the optical black coating.

In one embodiment, the film is deposited on a glass wafer, in particular on a non-polished surface of a glass wafer.

In one embodiment, the film is deposited on a glass wafer having a refractive index of more than 1.6, in particular 1.7 to 2.1, for example 1.75 to 2.3 at 589 nm. In one embodiment, the film has a refractive index of 1.75 to 1.98 at 589 nm. In one embodiment, the film has a refractive index of 1.99 to 2.02 at 589 nm.

The refractive index of the film deposited on the optical substrate corresponds to or is equal to that of the optical substrate. Thus, in one embodiment, the refractive index of the film differs no more than ±0.4 units, in particular no more than ±0.1 units, in particular no more than ±0.05 units, from that of the optical substrate at 589 nm.

In one embodiment, the film applied on a flat glass wafer exhibits a ratio of specular reflection to diffuse reflection greater than 10:1, in particular greater than 100:1.

The optical substrate typically has a thickness in the range of 100 μm to 10 000 μm, for example 150 to 1500 μm or 300 to 1500 μm.

In one embodiment, the coating film has a thickness of 5 to 100 μm and it is deposited on an optical substrate having a thickness of 150 to 1500 μm or 300 to 1500 μm.

In one embodiment, the reflection at an interface between the optical substrate and the coating film is less than 2% of the reflection at an interface between the optical substrate and air at 420-700 nm.

In one embodiment, a composition for coating of optical substrates, comprises, consists of or consists essentially of
5 to 100 parts by weight of a curable polymer;
5 to 100 parts by weight of nanoparticles; and
0.1 to 10 parts by weight of black pigment.

In the composition, the nanoparticles and black pigment are typically mixed, in particular evenly mixed, with the curable polymer.

In addition to the above components, the composition contains, in some embodiments, a solvent capable of least partially dissolving the curable polymer. Typically, the solvent makes up 5 to 90% of the total weight of the composition, for example 10 to 80% of the total weight of the composition.

In one embodiment, a composition for coating of optical substrates, comprises, consists of or consists essentially of a mixture of
5 to 80 parts by weight of a curable polymer;
10 to 80 parts by weight of nanoparticles;
1 to 20 parts by weight of black pigment; and optionally
10 to 60 parts by weight of a liquid capable of least partially dissolving the curable polymer.

In one embodiment, the curable polymer has a molecular weight (Mw) of 500 to 100 000 g/mol. Typically, the curable polymer exhibits reactive groups which will allow for cross-linking of the polymer during curing.

In one embodiment, the curable polymer comprises a siloxane polymer.

To make the siloxane polymer, a first compound is provided having a chemical formula SiR¹ₐR²₄₋ₐ where a is from 1 to 3, R¹ is a reactive group, and R² is an alkyl group or an aryl group. Also provided is a second compound that has the chemical formula SiR³_{b}R⁴_{c}R⁵_{4-(b+c)} where R³ is a cross-linking functional group, R⁴ is a reactive group, and R 5 is an alkyl or aryl group, and where b=1 to 2, and c=1 to (4−b). An optional third compound is provided along with the first and second compounds, to be polymerized therewith. Also an optional fourth compound can be provided along with the first. second and third compounds, to be polymerized therewith. The third and fourth compounds may have the chemical formula SiR⁹_{f}R¹⁰_{g} where R 9 is a reactive group and f=1 to 4, and where R¹⁰ is an alkyl or aryl group and g=4−f. If both third and fourth compounds are provided along with the first and second compounds, the third and fourth compounds are not identical. The first, second, third and fourth compounds may be provided in any sequence, and oligomeric partially polymerized versions of any of these compounds may be provided in place of the above-mentioned monomers.

The first, second, third and fourth compounds, and any compounds recited hereinbelow, if such compounds have more than one of a single type of “R” group such as a plurality of aryl or alkyl groups, or a plurality of reactive groups, or a plurality of cross-linking functional groups, etc., the multiple R groups are independently selected so as to be the same or different at each occurrence. For example, if the first compound is SiR¹₂R²₂, the multiple R¹ groups are independently selected so as to be the same or different from each other. Likewise, the multiple R 2 groups are independently selected so as to be the same or different from each other. The same is for any other compounds mentioned herein, unless explicitly stated otherwise.

A catalyst is also provided. The catalyst may be a base catalyst, or other catalyst as mentioned below. The catalyst provided should be capable of polymerizing the first and second compounds together. As mentioned above, the order of the addition of the compounds and catalyst may be in any desired order. The various components provided together are polymerized to create a siloxane polymeric material having a desired molecular weight and viscosity. After the polymerization, particles, such as microparticles, nanoparticles or other desired particles are added, along with other optional components such as coupling agents, catalyst, stabilizers, adhesion promoters, and the like. The combination of the components of the composition can be performed in any desired order.

More particularly, in one example, a siloxane polymer is made by polymerizing first and second compounds, where the first compound has the chemical formula I

SiR¹ₐR²₄₋ₐ I
wherein
a is an integer from 1 to 3,
R¹ is a reactive group, and
R² is an alkyl group or an aryl group,
and the second compound has the chemical formula II

SiR³_{b}R⁴_{c}R⁵_{4-(b+c)} II
wherein
R³ is a cross-linking functional group,
R⁴ is a reactive group, and
R⁵ is an alkyl or aryl group, and where
b is an integer 1 to 2, and c is an integer 1 to (4-b).

The first compound may have from 1 to 3 alkyl or aryl groups (R 2) bound to the silicon in the compound. A combination of different alkyl groups, a combination of different aryl groups, or a combination of both alkyl and aryl groups is possible. If an alkyl group, the alkyl contains preferably 1 to 18, more preferably 1 to 14 and particularly preferred 1 to 12 carbon atoms. Shorter alkyl groups, such as from 1 to 6 carbons (e.g. from 2 to 6 carbon atoms) are envisioned. The alkyl group can be branched at the alpha or beta position with one or more, preferably two, C1 to C6 alkyl groups. In particular, the alkyl group is a lower alkyl containing 1 to 6 carbon atoms, which optionally bears 1 to 3 substituents selected from methyl and halogen. Methyl, ethyl, n-propyl, i-propyl, n-butyl, i-butyl and t-butyl, are particularly preferred. A cyclic alkyl group is also possible like cyclohexyl, adamantyl, norbornene or norbornyl.

If R² is an aryl group, the aryl group can be phenyl, which optionally bears 1 to 5 substituents selected from halogen, alkyl or alkenyl on the ring, or naphthyl, which optionally bear 1 to 11 substituents selected from halogen alkyl or alkenyl on the ring structure, the substituents being optionally fluorinated (including per-fluorinated or partially fluorinated). If the aryl group is a polyaromatic group, the polyaromatic group can be for example anthracene, naphthalene, phenanthere, tetracene which optionally can bear 1-8 substituents or can be also optionally ‘spaced’ from the silicon atom by alkyl, alkenyl, alkynyl or aryl groups containing 1-12 carbons. A single ring structure such as phenyl may also be spaced from the silicon atom in this way.

The siloxane polymer is made by performing a polymerization reaction, preferably a base catalyzed polymerization reaction between the first and second compounds. Optional additional compounds, as set forth below, can be included as part of the polymerization reaction.

The first compound can have any suitable reactive group R′, such as a hydroxyl, halogen, alkoxy, carboxyl, amine or acyloxy group. If, for example, the reactive group in the first compound is an —OH group, more particular examples of the first compound can include silanediols such as diphenylsilanediol, dimethylsilanediol, di-isopropylsilanediol, di-n-propylsilanediol, di-n-butylsilanediol, di-t-butylsilanediol, di-isobutylsilanediol, phenylmethylsilanediol and dicyclohexylsilanediol among others.

The second compound can have any suitable reactive group R⁴, such as a hydroxyl, halogen, alkoxy, carboxyl, amine or acyloxy group, which can be the same as or different from the reactive group in the first compound. Thus, R⁴ can have the same meanings as R¹ above. In one example, the reactive group is not —H in either the first or second compound (or any compounds that take part in the polymerization reaction to form the siloxane polymer—e.g. the third compound, etc.), such that the resulting siloxane polymer has an absence of any, or substantially any, H groups bonded directly to the Si in the siloxane polymer.

Group R⁵, if present at all in the second compound, is independently an alkyl or aryl groups such as for group R¹ in the first compound. Thus, R⁵ can have the same meanings as R² above. The alkyl or aryl group R⁵ can be the same or different from the group R 2 in the first compound.

The cross-linking reactive group R³ of the second compound can be any functional group that can be cross-linked by acid, base, radical or thermal catalyzed reactions. These functional groups can be for example any epoxide, oxetane, acrylate, alkenyl, alkynyl or thiol group.

If an epoxide group, it can be a cyclic ether with three ring atoms that can be cross-linked using acid, base and thermal catalyzed reactions. Examples of these epoxide containing cross-linking groups are glycidoxypropyl and (3,4-Epoxycyclohexyl)ethyl) groups to mention few

If an oxetane group, it can be a cyclic ether with four ring atoms that can be cross-linked using acid, base and thermal catalyzed reactions. Examples of such oxetane containing silanes include 3-(3-ethyl-3-oxetanylinethoxy)propyltriethoxysilane, 3-(3-Methyl-3-oxetanylmethoxy)propyltriethoxysilane, 3-(3-ethyl-3-oxetanylmethoxy)propyltrimethoxysilane or 3-(3-Methyl-3-oxetanylmethoxy)propyltrimethoxysilane, to mention a few.

If an acrylate group, it can be an acrylate or methacrylate that can be cross-linked using radical initiators which can be activated by heat. Examples of such acrylate containing silanes are 3-(trimethoxysilyl)propylmethacrylate, 3-(trimethoxysilyl)-propylacrylate, 3-(triethoxysilyl)propylmethacrylate, 3-(triethoxysilyl)propylacrylate, 3-(dimethoxymethylsilyl)propylmethacrylate or 3-(methoxydimethylsilyl)propylmethacrylate, to mention a few.

If an alkenyl group, such a group may have preferably 2 to 18, more preferably 2 to 14 and particularly preferred 2 to 12 carbon atoms. The ethylenic, i.e. two carbon atoms bonded with double bond, group is preferably located at the position 2 or higher, related to the Si atom in the molecule. Branched alkenyl is preferably branched at the alpha or beta position with one and more, preferably two, C1 to C6 alkyl, alkenyl or alkynyl groups, optionally fluorinated or perfluorinated alkyl, alkenyl or alkynyl groups.

If an alkynyl group, it may have preferably 2 to 18, more preferably 2 to 14 and particularly preferred 2 to 12 carbon atoms. The ethylinic group, i.e. two carbon atoms bonded with triple bond, group is preferably located at the position 2 or higher, related to the Si or M atom in the molecule. Branched alkynyl is preferably branched at the alpha or beta position with one and more, preferably two, C1 to C6 alkyl, alkenyl or alkynyl groups, optionally per-fluorinated alkyl, alkenyl or alkynyl groups. If a thiol group, it may be any organosulfur compound containing carbon-bonded sulfhydryl group. Examples of thiol containing silanes are 3-mercaptopropyltrimethoxysilane and 3-mercaptopropyltriethoxysilane.

The reactive group in the second compound can be an alkoxy group. The alkyl residue of the alkoxy groups can be linear or branched. Preferably, the alkoxy groups are comprised of lower alkoxy groups having 1 to 6 carbon atoms, such as methoxy, ethoxy, propoxy and t-butoxy groups. A particular example of the second compound is an silane, such as 2-(3,4-Epoxycyclohexyl)ethyltrimethoxysilane, 2-(3,4-epoxycyclohexyl)ethyltriethoxysilane, 3-(Trimethoxy silyl)propylmethacrylate, 3-(Trimethoxy silyl)propylacrylate, (3-glycidyloxypropyl)trimethoxysilane, or 3-glycidoxypropyltriethoxysilane, 3-methacryloxypropyltrimethoxysilane, 3-acryloxypropyltrimethoxysilane, among others.

A third and fourth compound may be provided along with the first and second compounds, to be polymerized therewith. The third and fourth compounds may independently have the chemical formula III

SiR⁹_{f}R¹⁰_{g} III
wherein
R⁹ is a reactive group and
f is an integer 1 to 4, and where
R¹⁰ is an alkyl or aryl group and
g is an integer 4-f

The third and fourth compound of formula III can have any suitable reactive group R⁹, such as a hydroxyl, halogen, alkoxy, carboxyl, amine or acyloxy group, which can be the same as or different from the reactive group in the first compound or in the second compound. Thus, R⁹ can have the same meanings as R¹ or R⁴ above. Thus, the reactive group in the third and fourth compound can be an alkoxy group. The alkyl residue of the alkoxy groups can be linear or branched. Preferably, the alkoxy groups are comprised of lower alkoxy groups having 1 to 6 carbon atoms, such as methoxy, ethoxy, propoxy and t-butoxy groups. Group R¹⁰, if present at all in the third and/or fourth compound, is independently an alkyl or aryl groups as listed for group R² in the first compound and for group R⁵ in the second compound. Thus, R¹⁰ can have the same meanings as R² or R⁵ above. The alkyl or aryl group R¹⁰ can be the same or different from the group R² in the first compound and group R⁵ in the second compound.

One example of a third or fourth compound is tetramethoxysilane. Other examples include phenylmethyldimethoxysilane, trimethylmethoxysilane, dimethyldimethoxysilanesilane, vinyltrimethoxysilane, allyltrimethoxysilane, methyltrimethoxysilane, methyltriethoxysilane, methyl tripropoxysilane, propylethyltrimethoxysilane, phenylmethyldiethoxy silane, trimethylethoxysilane, dimethyldiethoxysilanesilane, vinyltriethoxysilane, allyltriethoxysilane, methyltriethoxysilane, methyl tripropoxysilane, propylethyltrimethoxysilane, ethyltriethoxysilane, vinyltrimethoxysilane, vinyltriethoxysilane, among others.

If a third compound is provided along with the first and second compounds, the third compound is different from the first and second compounds.

If a fourth compound is provided along with the first, second and third compounds, the fourth compounds is different from the third compound and preferably from the first and second compounds.

Though the polymerization of the first and second compounds (and optionally third and optionally fourth compounds) can be performed using an acid catalyst, a base catalyst is preferred. The base catalyst used in a base catalyzed polymerization between the first and second compounds can be any suitable basic compound. Examples of these basic compounds are any amines like triethylamine and any barium hydroxide like barium hydroxide, barium hydroxide monohydrate, barium hydroxide octahydrate, among others. Other basic catalysts include magnesium oxide, calcium oxide, barium oxide, ammonia, ammonium perchlorate, sodium hydroxide, potassium hydroxide, imidazone or n-butyl amine. In one particular example the base catalyst is Ba(OH)₂. The base catalyst can be provided, relative to the first and second compounds together, at a weight percent of less than 0.5%, or at lower amounts such as at a weight percent of less than 0.1%.

Polymerization can be carried out in melt phase or in liquid medium. The temperature is in the range of about 20 to 200° C., typically about 25 to 160° C., in particular about 40 to 120° C. Generally, polymerization is carried out at ambient pressure and the maximum temperature is set by the boiling point of any solvent used. Polymerization can be carried out at refluxing conditions. Other pressures and temperatures are also possible. The molar ratio of the first compound to the second compound can be 95:5 to 5:95, in particular 90:10 to 10:90, preferably 80:20 to 20:80. In a preferred example, the molar ratio of the first compound to the second compound (or second plus other compounds that take part in the polymerization reaction—see below) is at least 40:60, or even 45:55 or higher.

In one example, the first compound has —OH groups as the reactive groups and the second compound has alkoxy groups as the reactive groups. Preferably, the total number of —OH groups for the amount of the first compound added is not more than the total number of reactive groups, e.g. alkoxy groups in the second compound, and preferably less than the total number of reactive groups in the second compound (or in the second compound plus any other compounds added with alkoxy groups, e.g. an added tetramethoxysilane or other third compound involved in the polymerization reaction, as mentioned herein). With the alkoxy groups outnumbering the hydroxyl groups, all or substantially all of the —OH groups will react and be removed from the siloxane, such as methanol if the alkoxysilane is a methoxysilane, ethanol if the alkoxysilane is ethoxysilane, etc. Though the number of —OH groups in the first compound and the number of the reactive groups in the second compound (preferably other than —OH groups) can be substantially the same, it is preferably that the total number of reactive groups in the second compound outnumber the —OH groups in the first compound by 10% or more, preferably by 25% or more. In some embodiments the number of second compound reactive groups outnumber the first compound —OH groups by 40% or more, or even 60% or more, 75% or more, or as high as 100% or more. The methanol, ethanol or other by-product of the polymerization reaction depending upon the compounds selected, is removed after polymerization, preferably evaporated out in a drying chamber.

The siloxane polymer is first provided in the form of a prepolymer, having a molecular weight (Mw) of 500 to 100000 g/mol, in particular having a weight average molecular weight of 500 to 5,000 g/mol.

In one particular embodiment, the curable polymer is a siloxane prepolymer having a molecular weight (Mw) of 500 to 2500 g/mol, and the siloxane prepolymer preferably exhibits one or several reactive groups in particular selected from epoxy, glycidyl, vinyl, allyl, acrylate and methacrylate and combinations thereof.

Upon curing, the molecular weight is typically up to 200,000 g/mol or greater.

In one embodiment, the nanoparticles are selected from metal oxide particles, such as titanium dioxide and zirconium oxide.

In one embodiment, the nanoparticles have an average particle size of 1 to 200 nm, in particular 2 to 100 nm.

In one embodiment, the nanoparticles are generally aggregate-free. In one embodiment, nanoparticles are being used as coated nanoparticles, the coating being employed to prevent agglomeration of the particles.

In one embodiment, the nanoparticles are provided as a never-dried dispersion.

In one embodiment, the nanoparticles are mixed with the curable polymer at a weight ratio of from 95:5 to 5:95, in particular from 90:10 to 10:90, for example from 85:15 to 60:40. In one embodiment, the black pigment is selected from soot, carbon black, graphite, and metal oxide particles and combinations thereof. The black pigment can also comprise black organic pigments. In one embodiment, black pigments are provided in the form of non-conductive metal oxide particles.

In one embodiment, the composition comprises black pigment in a concentration of 5 to 10%, calculated from the weight of the curable polymer and the nanoparticles.

In one embodiment, the composition comprises non-aggregated black pigments.

In one embodiment, the composition comprises a thermal initiator for achieving curing of the curable polymer.

The composition preferably comprises additives capable of adjusting properties of the composition. Such additives can be selected from the group of additives capable of adjusting wetting, adhesion, thixotrophy, foaming properties of the composition, as well as and combinations thereof. Typically, the concentration of the additives is 0.01 to 10%, in particular about 0.1 to 5% of the total weight of the composition, including any solvent.

In one embodiment, the composition comprises a solvent for the curable polymer. The solvent may optionally be selected such that it is also capable of dissolving the black pigment, in particular when organic black pigments are being used.

In one embodiment, the solvent primarily dissolves the curable polymer whereas the nanoparticles and the black pigment are dispersed in the liquid phase rather than dissolved therein.

The dynamic viscosity, at 25° C., of the composition is generally in the range of 5 mPas-500,000 mPas, for example about 100 to 200,000 mPas, in particular 200 to 100,000 mPas, such as 1000 to 10,000 mPas, determined by a rheometer at 10 s⁻¹ shear rate.

For application, the viscosity of the composition can be adjusted for example by adjusting the solids content of the composition. Generally, the solids content is in the range of 10 to 100% by weight, in particular about 30 to 100% by weight, for example 40 to 100% by weight of the total composition.

In one embodiment, the viscosity of the composition is adjusted by adjusting the amount of solvent for the curable polymer. Thus, the viscosity can be adjusted by adding 10 to 200 parts by weight of a liquid capable of dissolving the curable polymer to 100 parts of solids, formed by polymer, nanoparticles and black pigments.

The solvent is, for example, selected from the group of organic solvents, such as ketones, ethers, alcohols and esters. As specific examples the following can be mentioned: acetone, tetrahydrofuran (THF), toluene, methanol, ethanol, 2-propanol, propylene glycol monomethyl ether, methyl-tert-butylether (MTBE), propylene glycol propyl ether, propylene glycol propyl ether (PnP), propyleneglycolmonomethylether acetate (PGMEA) and propyleneglycolmonomethylether PGME.

In one embodiment, propyleneglycolmonomethylether acetate (abbreviated “PGMEA”) is being used.

In one embodiment, a composition for coating of optical substrates, in particular according to one or several of the above-discussed embodiments, is provided by the steps of
providing a curable polymer in a solvent phase;
adding to the curable polymer in the solvent phase nanoparticles to provide a mixture, and
to the mixture thus obtained adding black pigment.

In another embodiment, the curable polymer is mixed in essentially solvent-free state with nanoparticles dispersed in a solvent for the polymer.

In one embodiment, during the preparation of the composition aggregation of the black pigment is prevented.

In one embodiment, the black pigment is added to a mixture formed by the other components to form a modified mixture which is then subjected to milling to disperse or dissolve the black pigment.

The composition can be applied to the surface by a number of application methods. In one embodiment, the application method is selected from the group consisting of contact-free or contacting methods, in particular from the group of dispensing, spraying, slit-coating, spin-coating, doctor blade coating, curtain coating, contact-free or contacting painting and printing, such as flexo or screen printing.

In one embodiment, the composition is used for high refractive index edge-blackening of a high refractive index material. Typically, the high refractive index material comprises a glass substrate, in particular a glass substrate, having a non-polished rough surface onto which the composition is coated.

The following non-limiting example illustrates some embodiments.

### EXAMPLE

Synthesis of Siloxane Polymer:

A 500 mL round bottom flask with stirring bar and reflux condenser was charged with diphenylsilanediol (60 g, 45 mol %), 2-(3,4-Epoxycyclohexyl)ethyl]trimethoxysilane (55.67 g, 36.7 mol %) and tetramethoxysilane (17.20 g, 18.3 mol %). The flask was heated to 80° C. under nitrogen atmosphere and 0.08 g of barium hydroxide monohydrate dissolved in 1 mL of methanol was added dropwise to the mixture of silanes. The silane mixture was stirred at 80° C. for 30 min during the diphenylsilanediol reacted with alkoxysilanes. After 30 min, formed methanol was evaporated off under vacuum. The siloxane polymer had viscosity of 1000 mPas and Mw of 1200.

Forming of Composition:

Siloxane polymer was mixed with the nanoparticle solution (TiO₂, average particle size 87 nm) in PGMEA to achieve a predetermined ratio between polymer and nanoparticles. Curing catalyst (CXC-1612) and black absorbing pigment (Orasol black X55) were added and the formulation was mixed thoroughly. Finally, the composition is milled using three-roll-mill to obtain a homogeneous mixture.

Four different formulations were made (Formulations 1-4) and the composition is mentioned in Table 1.

The refractive index of the formulations was measured from the formulation before adding the black absorbing pigment.

Samples of the siloxane polymer and nanoparticle solution were spin coated on silicon wafer and cured at 130° C. for 15 minutes. The refractive index was measured with ellipsometer (Woollam alpha-SE) at a wavelength of 589 nm.

TABLE 1

| | Formu- | Formu- | Formu- | Formu- |
|---|---|---|---|---|
| Component | lation 1 | lation 2 | lation 3 | lation 4 |
| Siloxane polymer | 58.8% | 29.4% | 19.1% | 11.8% |
| TiO₂ nanoparticle | 0.0% | 29.4% | 39.7% | 47.1% |
| Orasol Black X55 | 4.8% | 4.8% | 4.8% | 4.8% |
| Solvent (PGMEA) | 36.3% | 36.3% | 36.3% | 36.3% |
| Catalyst (CXC-1612) | 0.1% | 0.1% | 0.1% | 0.1% |
| Analyzed RI | 1.55 | 1.71 | 1.80 | 1.89 |
| at 589 nm | | | | |

### APPLICATION EXAMPLES

For demonstration of the properties, the formulations were applied as a thin 30 μm layer on a high RI glass substrate (RI 1.9 at 589 nm) by doctor blading. After application as a thin film, the films were cured at elevated temperature, in this example at 130° C. for 15 minutes. Curing of the formulation results in a reflective smooth black surface against the air surface. After curing, the thicknesses for formulations 1, 2, 3 and 4 are ca. 30 μm.

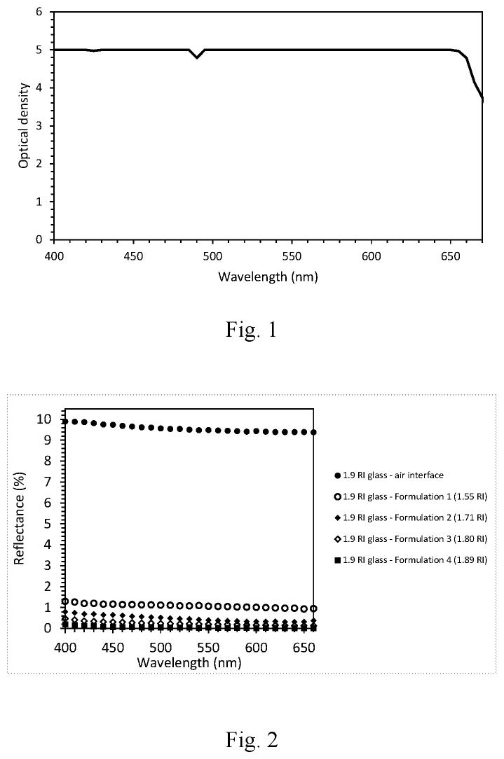

The optical density of the formulations deposited on high refractive index glass wafers was measured at normal incidence with a Perkin-Elmer Lambda 25 spectrophotometer. An example of the resulting optical density spectra is shown in FIG. 1 for formulation 4 at 26 μm thickness. Similar spectra are measured for the other compositions.

The spectrum demonstrates that the formulations with the 30 μm thicknesses have optical densities over 4 within the 400-665 nm wavelength range. The upper limit of the measurement accuracy of the spectrophotometer is 4.5, and all data above 5 is limited to 5, indicating that the optical density of the films is higher than 4.5 in most of the area.

The functioning of the formulations as an edge-blackening material is shown by measuring the reflectance from the interface between the high refractive index glass and the formulations 1-4. The reflectance was measured using Konica Minolta CM-3600A spectrophotometer, which can measure specular and total reflectance. The incidence angle of the light is 8°. The sample was placed to the equipment with the non-coated glass side towards the light beam. It should be noted that measurement of the reflectance of the glass-coating interface is not possible without the reflectance from the air-glass interface, which is why this reflection is corrected from the reflectance data as follows.

Firstly, the reflectance of the clean substrate is measured. The clean substrates have two identical surfaces with reflectivity r 1 and the resulting measured specular reflectance can be approximated to result from the reflectivity as

R=+r₁+r₁·(1−r₁)²+r₁³·(1−r₁)².

The single interface reflectivity is calculated with the former equation from the measured substrate data.

With the reflectivities of air-glass interface, r₁ and glass-coating interface, r₂, the reflectance with the sample coating can be approximated as

$${R}_{sample} = {r}_{1} + {r}_{2} \cdot {( 1 - {r}_{1} )}^{2} . \\ {r}_{2} = \frac{{R}_{sample} - {r}_{1}}{{( 1 - {r}_{1} )}^{2}} .$$

The calculated reflectivity values of glass-coating interfaces, r₂, are shown in FIG. 2. The reference value for non-coated glass is reflectivity r₁.

The results show that matching the real part of the refractive index to the substrate significantly decreases the reflectance. This demonstrates the functioning of the material in edge-blackening.

1-31. (canceled)

32. A black coating comprising:
a film comprising a cured polymer mixed with nanoparticles and black pigment, said film having a refractive index of more than 1.6.

33. The black coating according to claim 32, wherein said film has a thickness of 1 to 200 μm.

34. The black coating according to claim 32, wherein the film, at a film thickness of 30 has an optical density of more than 4 at wavelengths between 400 and 665 nm.

35. The black coating according to claim 32, wherein the film has a refractive index of more than 1.75.

36. The black coating according to claim 32, wherein the nanoparticles are selected from metal oxide particles having a Z-average particle diameter of 1 to 200 nm.

37. The black coating according to claim 32, wherein the weight ratio of nanoparticles to cured polymer amounts to 85:15 to 60:40.

38. The black coating according to claim 32, wherein the black pigment is selected from the group consisting of soot, carbon black, carbon nanotubes, graphite, organic pigments, metal complex dyes, metal oxide particles, and combinations thereof.

39. The black coating according to claim 32, wherein the film is on an optical substrate, wherein the refractive index of the film differs no more than ±0.4 units from that of the optical substrate, said refractive index being measured at 589 nm.

40. The black coating according to claim 32, wherein the film is deposited on at least one optical substrate having a refractive index of more than 1.6, and wherein the reflection at an interface between the at least one optical substrate and the coating film is less than 10% of the reflection at an interface between the at least one optical substrate and air at 400-665 nm.

41. The black coating according to claim 32, wherein the cured polymer is a siloxane polymer.

42. A composition for coating of optical substrates, comprising:
5 to 100 parts by weight of a curable polymer;
5 to 100 parts by weight of nanoparticles; and
0.1 to 20 parts by weight of black pigment;
said nanoparticles and black pigment being mixed with the curable polymer.

43. The composition according to claim 42, wherein the curable polymer comprises one or more siloxane prepolymers having a molecular weight (Mw) of 500 to 100000 g/mol and exhibiting one or several reactive groups selected from the group consisting of epoxy, glycidyl, vinyl, allyl, acrylate, hydride, thiol, methacrylate, and combinations thereof.

44. The composition according to claim 42, wherein the nanoparticles comprise metal oxide particles having a Z-average particle diameter of 1 to 200 nm.

45. The composition according to claim 42, comprising black pigment in concentration of 1 to 20%, calculated from the total weight of the composition excluding solvent.

46. The composition according to claim 42, comprising a solvent to modify the viscosity of the composition, said solvent optionally also being capable of dissolving the black pigment.

47. The composition according to claim 42, wherein the solids content of the composition is 20 to 100% by weight, the rest comprising a solvent.

48. The composition according to claim 42, further comprising 0.01 to 5% of the total weight of the composition of a curing catalyst for curing of the curable polymer.

49. The composition according to claim 42 having a dynamic viscosity of 5 mPas-1,000,000 mPas at 25° C. using a rheometer at 10 s⁻¹ shear rate.

50. The composition according to claim 42, comprising:
10 to 60 parts by weight of a curable polymer;
20 to 50 parts by weight of nanoparticles;
1 to 20 parts by weight of black pigment; and optionally
10 to 40 parts by weight of a solvent capable of at least partially dissolving the curable polymer.

51. A method of producing a composition for coating of optical substrates comprising the steps of:
providing a curable polymer in a solvent phase;
adding to the curable polymer in the solvent phase nanoparticles to provide a mixture,
adding to the mixture thus obtained a black pigment.

52. The method according to claim 51, wherein the curable polymer is mixed in essentially a solvent-free state with nanoparticles dispersed in a solvent for the polymer.

53. An optical substrate comprising a black coating according to claim 32.
